(19) United States
(12) Patent Application Publication
(10) Pub. No.: US 2020/0057831 A1
(43) Pub. Date: Feb. 20, 2020

(54) REAL-TIME GENERATION OF SYNTHETIC DATA FROM MULTI-SHOT STRUCTURED LIGHT SENSORS FOR THREE-DIMENSIONAL OBJECT POSE ESTIMATION

(71) Applicant: Siemens Mobility GmbH, Munich (DE)

(72) Inventors: Ziyan Wu, Princeton, NJ (US); Shanhui Sun, Princeton, NJ (US); Stefan Kluckner, Berlin (DE); Terrence Chen, Princeton, NJ (US); Jan Ernst, Princeton, NJ (US)

(21) Appl. No.: 16/487,568

(22) PCT Filed: Feb. 23, 2017
(86) PCT No.: PCT/US2017/018995

§ 371 Date: Aug. 21, 2019

(51) Int. Cl. G06F 17/50; G06T 7/521; G06T 7/70; G06N 20/00

(52) U.S. Cl. CPC G06F 17/5009; G06T 7/521; G06T 2207/10028; G06N 20/00; G06T 2207/20081; G06T 7/70

(57) ABSTRACT

The present embodiments relate to generating synthetic depth data. By way of introduction, the present embodiments described below include apparatuses and methods for modeling the characteristics of a real-world light sensor and generating realistic synthetic depth data accurately representing depth data as if captured by the real-world light sensor. To generate accurate depth data, a sequence of procedures are applied to depth images rendered from a three-dimensional model. The sequence of procedures simulate the underlying mechanism of the real-world sensor. By simulating the real-world sensor, parameters relating to the projection and capture of the sensor, environmental illuminations, image processing and motion are accurately modeled for generating depth data.

### BACKGROUND

Three-dimensional pose estimation has many useful applications, such as estimating a pose of a complex machine for identifying a component or replacement part of the machine. For example, a replacement part for a high speed train may be identified by capturing an image of the part. Using depth images, the pose of the train, and ultimately the part needing replacement, is identified. By identifying the part using the estimated pose, a replacement part may be ordered without needing or providing a part number or part description.

Mobile devices with a multi-shot structured light three-dimensional sensor are used to recognize an object and estimate its three-dimensional pose. To estimate a three-dimensional pose, an algorithm may be trained using deep learning, requiring a large amount of labeled image data captured by the same three-dimensional sensor. In real-world scenarios, it is very difficult to collect the large amount of real image data required. Further, the real image data of the target objects must be accurately labeled with ground-truth poses. Collecting real image data and accurately labeling the ground-truth poses is even more difficult if the system is trained to recognize expected background variations.

A three-dimensional rendering engine can generate synthetic depth data to be used for training purposes. Synthetic depth data with ground-truth poses are generated using computer-aided design (CAD) models of the target objects and simulated sensor information, such as environmental simulation. Synthetic depth data generated by current environmental simulation platforms fail to accurately simulate the actual characteristics of a sensor and the sensor environment resulting in noise in a captured test image. By not accurately simulating the characteristics of a sensor and the sensor environment, performance of the three-dimensional object pose estimation algorithms is severely affected due to training based on fundamental differences between the synthetic data and the real sensor data. Generating synthetic data without considering various kinds of noise significantly affects the performance of the analytics in three-dimensional object recognition and pose retrieval applications.

### SUMMARY

The present embodiments relate to generating synthetic depth data. By way of introduction, the present embodiments described below include apparatuses and methods for modeling the characteristics of a real-world light sensor and generating realistic synthetic depth data accurately representing depth data as if captured by the real-world light sensor. To generate accurate depth data, a sequence of procedures are applied to depth images rendered from a three-dimensional model. The sequence of procedures simulate the underlying mechanism of the real-world sensor. By simulating the real-world sensor, parameters relating to the projection and capture of the sensor, environmental illuminations, image processing and motion are accurately modeled for generating depth data.

In a first aspect, a method for real-time synthetic depth data generation is provided. The method includes receiving three-dimensional computer-aided design (CAD) data, modeling a multi-shot pattern-based structured light sensor and generating synthetic depth data using the multi-shot pattern-based structured light sensor model and the three-dimensional CAD data.

In a second aspect, a system for synthetic depth data generation is provided. The system includes a memory configured to store a three-dimensional simulation of an object. The system also includes a processor configured to receive depth data of the object captured by a sensor of a mobile device, to generate a model of the sensor of the mobile device and to generate synthetic depth data based on the stored three-dimensional simulation of an object and the model of the sensor of the mobile device. The processor is also configured to train an algorithm based on the generated synthetic depth data, and to estimate a pose of the object based on the received depth data of the object using the trained algorithm.

In a third aspect, another method for synthetic depth data generation is provided. The method includes simulating a sensor for capturing depth data of a target object, simulating environmental illuminations for capturing depth data of the target object, simulating analytical processing of captured depth data of the target object and generating synthetic depth data of the target object based on the simulated sensor, environmental illuminations and analytical processing.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the embodiments. Moreover, in the figures, like reference numerals designate corresponding parts throughout the different views.

FIG. 1 illustrates a flowchart diagram of an embodiment of a method for synthetic depth data generation.

FIG. 2 illustrates an example real-time realistic synthetic depth data generation for multi-shot pattern-based structured light sensors.

FIG. 3 illustrates example categories of sequential projections of simulated multi-shot structured light sensors.

FIG. 4 illustrates an example simulating the sensor and test object inside the simulation environment.

FIG. 5 illustrates an example of generating synthetic depth data for multi-shot structured light sensors.

FIG. 6 illustrates an example of an ideal depth map rendering of a target object.

FIG. 7 illustrates an example of the realistically rendered depth map of a target object.

FIG. 8 illustrates another example of the realistically rendered depth map of a target object.

FIGS. 9-10 illustrate another example of the realistically rendered depth maps of a target object.

FIGS. 11-13 illustrates another example of the realistically rendered depth maps of a target object.

FIG. 14 illustrates a flowchart diagram of another embodiment of a method for synthetic depth data generation.

FIG. 15 illustrates system an embodiment of a system for synthetic depth data generation.

FIG. 16 illustrates system another embodiment of a system for synthetic depth data generation.

### DETAILED DESCRIPTION OF EXEMPLARY EMBODIMENTS

A technique is disclosed for generating accurate and realistic synthetic depth data for multi-shot structured light sensors, in real-time, using computer-aided design (CAD) models. Realistic synthetic depth data that is generated using data from CAD models allows for three-dimensional object recognition applications to estimate object poses in real-time based on deep learning where large amounts of accurately labeled training data is required. With a three-dimensional rendering engine, synthetic depth data is generated by simulating the camera and projector of the multi-shot structured light sensor. The synthetic depth data captures the characteristics of a real-world sensor, such as quantization effects, lens distortions, sensor noise, distorted patterns caused by motion between exposures and shutter effects, etc. The accurate and realistic synthetic depth data enables the object recognition applications to better estimate poses from depth data (e.g., a test image) captured by the real-world sensor. Compared statistically modeling the sensor noise or simulating reconstruction based on geometry information, accurately simulating the target object, the target environment, the real-world sensor and analytical processing generates more realistic synthetic depth data.

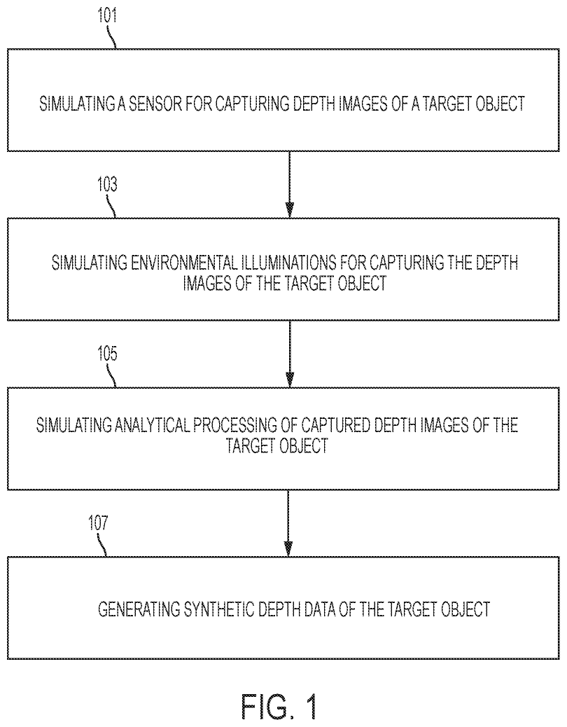

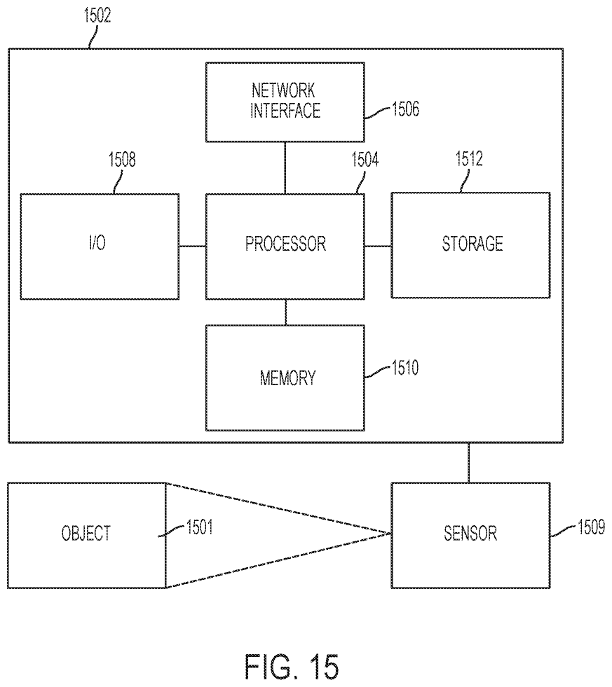

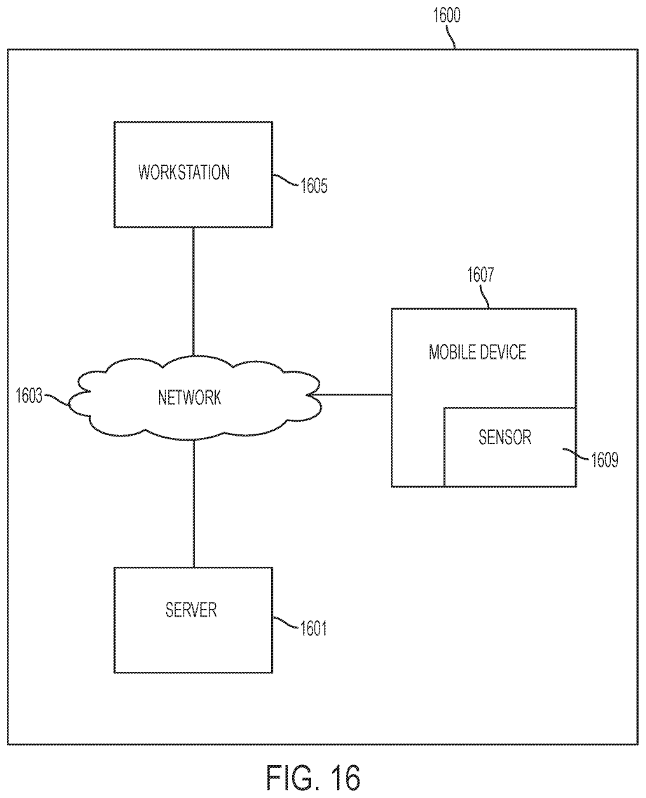

FIG. 1 illustrates a flowchart diagram of an embodiment of a method for synthetic depth data generation. The method is implemented by the system of FIG. 15 (discussed below), FIG. 16 (discussed below) and/or a different system. Additional, different or fewer acts may be provided. For example, one or more acts may be omitted, such as acts 103, 105 or 107. The method is provided in the order shown. Other orders may be provided and/or acts may be repeated. For example, act 105 may be repeated to simulate multiple stages of analytical processing. Further, the acts may be performed concurrently as parallel acts. For example, acts 101, 103 and 105 may be performed concurrently to simulate the sensor, environmental illuminations and analytical processing used to generate the synthetic depth data.

At act 101, a sensor is simulated for capturing depth data of a target object. One or more of several types of noise may be simulated related to the type of projector and camera of the light sensor, as well as characteristics of each individual real-world sensor of the same type. The simulated sensor is any three-dimensional scanner. For example, the simulated three-dimensional scanner is a camera with a structured-light sensor, or a structured-light scanner. A structured-light sensor is a scanner that includes a camera and a projector. The projector projects structured light patterns that are captured by the camera. A multi-shot structured light sensor captures multiple images of a projected pattern on the object. Information gathered from comparing the captured images of the pattern is used to generate the three-dimensional depth image of the object. For example, simulating the sensor includes modeling parameters of real-world projector and camera. Simulating the projector includes modeling the type and motion of the projected pattern. Simulating the camera includes modeling parameters of a real-world sensor, such as distortion, motion blur due to motion of the sensor, lens grain, background noise, etc. The type of pattern used and one or more of the characteristics of the sensor are modeled as parameters of the sensor.

At act 103, environmental illuminations are simulated for capturing depth data of the target object. One or more of several types of noise are simulated related to environmental lighting and surface material properties of the target object. To realistically generate synthetic depth data, factors related to the environment in which the real-world sensor captures depth data of the target object is simulated. For example, ambient light and other light sources interfere with projecting and capturing the projected patterns on a target object. Further, the material properties and the texture of the target object may also interfere with projecting and capturing the projected patterns on a target object. Simulating one or more environmental illuminations and the effect of the environmental illuminations on the projected pattern model additional parameters of the sensor.

At act 105, analytical processing of captured depth data is simulated. Further errors and approximations are introduced during processing of data captured by a real-world sensor. To realistically generate synthetic depth data, factors related matching reconstruction and/or hole-filling operations are simulated. Simulating analytical processing also includes modeling rendering parameters and the same reconstruction procedure as used by the light sensor and/or device(s) associated with the sensor. One or more characteristics of the analytical processing are modeled as additional parameters of the sensor.

At act 107, synthetic depth data of the target object is generating based on the simulated sensor, environmental illuminations and analytical processing. The synthetic depth data of the target object is generated using three-dimensional computer-aided design (CAD) modeling data. For example, synthetic depth data may be generated by first rendering depth images using the modeled sensor parameters, then applying the sensor parameters relating to environmental illuminations and analytical processing to the rendered images. A point cloud is generated (e.g., reconstructed) from the rendered images. By simulating various kinds of noise, realistic synthetic depth data is generated. The synthetic depth maps are very similar to the real depth maps captured by the real-world light sensor being modeled.

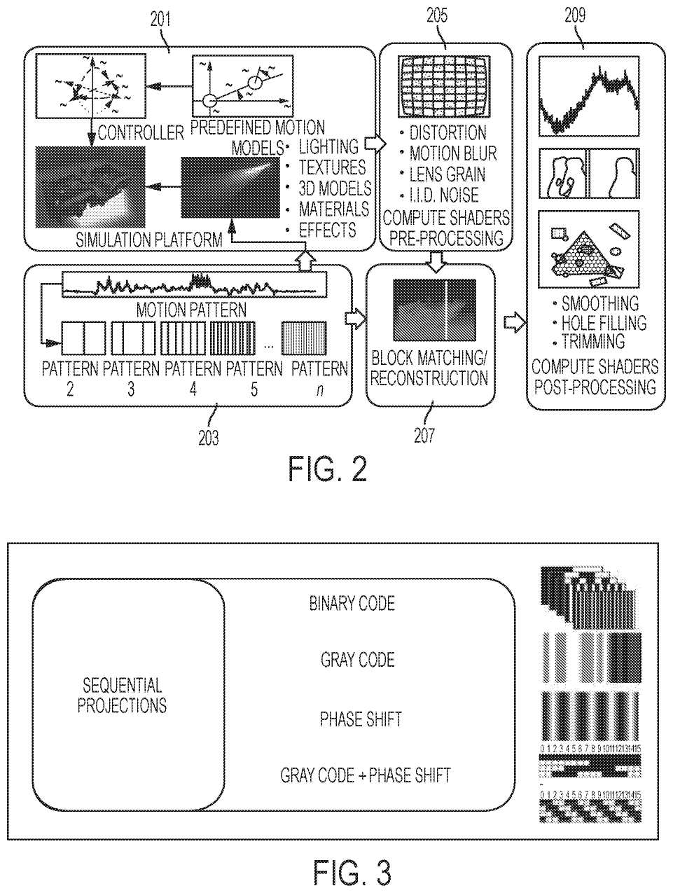

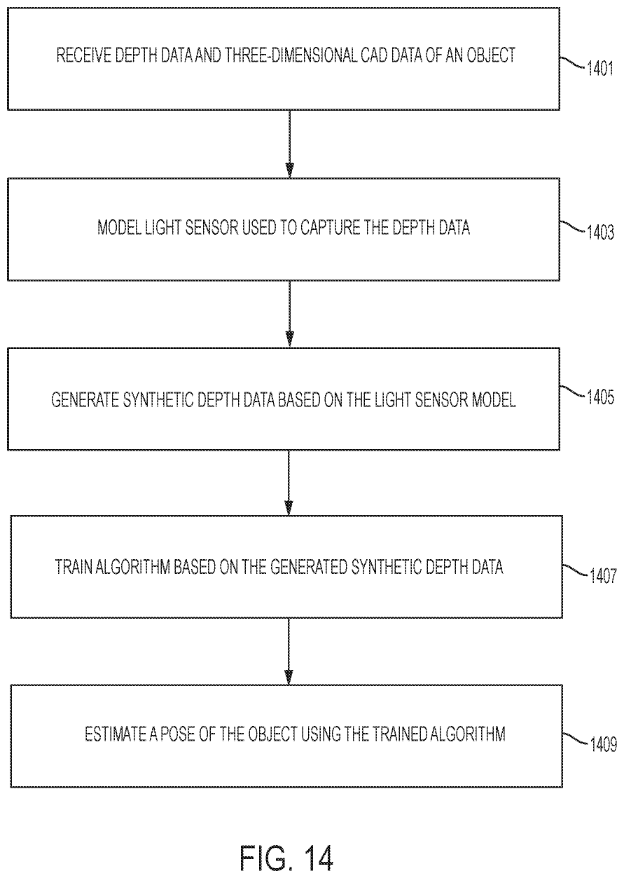

FIG. 2 illustrates an example of realistic synthetic depth data generation, in real-time, for multi-shot pattern-based structured light sensors. In this example, depth data is generated using the method depicted of FIG. 1, FIG. 14 (discussed below) and/or a different method, and is implemented by the system of FIG. 15 (discussed below), FIG. 16 (discussed below) and/or a different system.

The pattern simulator 203 simulates a projected pattern (e.g., sequential projections) by a projector of the light sensor for use by the simulation platform 201 in simulating the camera capture by the light sensor and block matching and reconstruction layer 207 in generating depth maps from rendered depth images.

For example, a pattern is simulated by the pattern simulator 203. For example, the pattern is a binary code pattern, simulating the projection of alternating strippes. Other motion pattern projections may be simulated. For example, FIG. 3 illustrates example categories of sequential projections used by simulated multi-shot structured light sensors. Many different types of projections may be simulated, including binary code, gray code, phase shift or gray code+phase shift.

As depicted in FIG. 2, the pattern simulator 203 simulates a motion pattern in binary code, or binary patterns. For example, Pattern 2 through Pattern N, may be simulated (e.g., alternating stripes of black and white) with increasing densities. Each pattern is projected onto the object and captured by the camera of the sensor. The increasing density of the alternating striped patterns may be represented by binary code (e.g., with zeros (0) representing black and ones (1) representing white). For Pattern 2, there are only two alternating stripes, represented by the binary code 000000111111. Pattern 3 has two black stripes and one white stripe, represented by the binary code 000111111000. Pattern 4 has three black stripes and three white stripes, represented by the binary code 001100110011. This increasing density pattern may be extrapolated out to Pattern N with as many alternating stripes as utilized by the real world projector. Other binary patterns may be used.

Referring to FIG. 3, other types of multi-shot projections may be simulated. For example, gray code may be simulated using N distinct intensity levels, instead of only two distinct intensity levels in binary code (e.g. black and white). Using gray code, alternating striped patterns of black, gray and white may be used (e.g., where N=3). Phase shift patterns may also be simulated, projecting striped patterns with intensity levels modulated in with a sinusoidal pattern. Any other pattern types may be used, such as a hybrid gray code+phase shift, photometric stereo, etc. As such, any kind of pattern is provided as an image asset to the simulation platform 201 in order to accurately simulate a light sensor, adapting the simulation to the pattern being used by the real-world sensor being simulated.

Although FIG. 3 depicts different types of multi-shot projections, single-shot projection types may also be simulated in order to simulate a single-shot light sensor. For example, continuous varying patterns (e.g., rainbow three-dimensional camera and continuously varying color code), stripe indexing (e.g., color coded stripes, segmented stripes, gray scale coded stripes and De Bruijn sequence), and grid indexing (e.g., pseudo random binary-dots, mini-patterns as code words, color coded grid and two-dimensional color coded dot array) may be simulated. Other pattern types and hybrid patterns of different pattern types may be simulated.

The pattern simulator 203 provides the simulated pattern to the simulation platform 201 and/or the block matching and reconstruction layer 207.

The simulation platform 201 uses the motion pattern 203 to simulate capturing depth data from the projected pattern using the camera of the light sensor. The simulation platform 201 may be implemented using a memory and controller of FIG. 15 (discussed below), FIG. 16 (discussed below) and/or a different system. For example, the simulation platform 201 is able to behave like a large panel of different types of depth sensors. The simulation platform 201 simulates the multi-shot light sensors (e.g., temporal structured light sensors) by simulating the capture of sequential projections on a target object. Accurately simulating a real-world light sensor allows the simulation platform 201 to render accurate three-dimensional depth images.

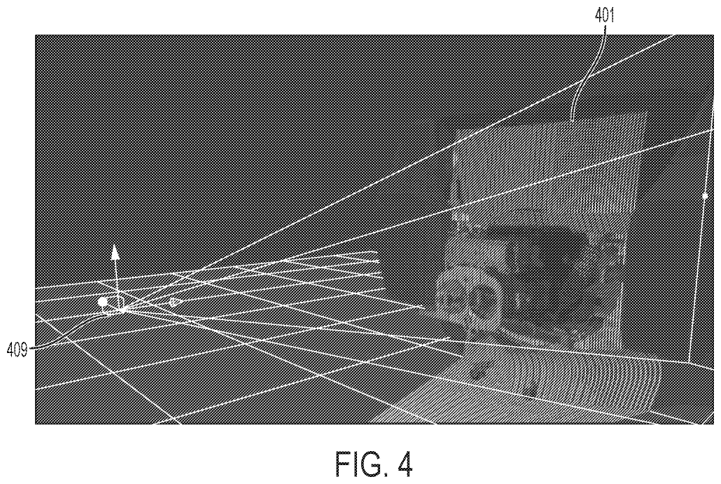

FIG. 4 illustrates an example simulating the sensor and test object inside the simulation environment. For example, using the simulation platform 201, a sensor 409, including a projector and a camera, is simulated. An object 401 is also simulated, based on a three-dimensional model of the object 401 (e.g., a three-dimensional CAD model). As depicted in FIG. 4, the object 401 is an engine of a high speed train. Any type of object may be simulated, based on a three-dimensional model of the object. A projected pattern by the sensor 409 is simulated on the object 401. As depicted in FIG. 4, the projected pattern is an alternating striped pattern. A camera of the sensor 409 is simulated to capture three-dimensional depth data of the object 401, using the same perspectives as the real-world sensor. Based on inferences drawn from data captured of the pattern projected on the object 401, accurate depth images may be rendered.

The sensor 409 is simulated to model the characteristics of a real-world light sensor. For example, the simulation platform 201 may receive the calibration of the real structured light sensor, including intrinsic characteristics and parameters of the sensor. The setup of the projector and camera of the real device is simulated to create a projector inside the simulation environment from a spot light model and a perspective camera (FIG. 4). Reconstruction of the pattern projected by the projector is simulated for the structured light sensor. Reconstruction associates each pixel with a simulated depth from the sensor. For example, red, green, blue+depth (RGB+D) data is simulated. These characteristics provide for simulation of noise are related to the real-world sensor structure.

Dynamic effects (e.g. motion between exposures) impacting the projection and capture of the light pattern are also simulated. Simulating the dynamic effects impacting projecting and capture account for human factors and other motion when capturing depth data. For example, as multiple images of different patterns are captured, the user of the light sensor may not hold the sensor perfectly still. Therefore, when modeling the acquisition of multi-shot structured light sensor, motion between each exposure is modeled to reflect the influence brought by exposure time, interval between exposures, motion blur and the number of exposures (e.g., different patterns) captured accounting for motion of the sensor. For example, predefined motion models may be used to simulate sensor motion between exposures to account for different dynamic effects.

The simulation platform 201 may also receive extrinsic characteristics and parameters relating to the sensor and the object, such as lighting characteristics and material properties of the object. Lighting effects are simulated for the real-world environment of the sensor 409 and the object 401. The simulation platform 201 accurately simulates lighting characteristics for rendering, as discussed below, relying on realistic lighting factors central to the behavior of structured light sensors. For example, ambient lighting and other light sources are simulated to account for the effects of different light on capturing the projected patterns. For example, strong ambient light strongly influences the ability of the camera to capture the projected image. In addition to lighting effects, the object 401 is also simulated to model the material characteristics of the object 401. Textures and material properties of the object 501 will impact capturing the projected patterns. For example, it may be difficult to project and capture a pattern on a shiny or textured object.

The aforementioned real-world characteristics are modeled as a set of parameters for the sensor 409 and the object 401. Using this extensive set of parameters (e.g., pattern images as assets, light cookies, editable camera parameters, etc.), the simulation platform 201 may be configured to behave like a large number of different types of depth sensors. The ability to simulate a large number of depth sensors allows the system to simulate a vast array of sensors for different mobile devices (e.g., smartphones and tablets), scanners and cameras.

The simulation platform 201 is further configured to render three-dimensional depth images using the modeled scanner 409 and object 401. The simulation platform 201 renders depth images using a three-dimensional model of the object (e.g., three-dimensional CAD model). For example, simulation platform 201 converts the simulated pattern projections into a square binary images. The converted pattern projections are used as light cookies (e.g., simulated patterns of the projector light source for rendering). Additionally, ambient and other light sources simulate environment illuminations and motion patterns of the sensor between exposure sets are incorporated into the rendered depth images. The depth images rendered by the simulation platform are ideal, or pure depth images from the three-dimensional model without additional effects due to the optics of the lens of the light senor or processing of the image data by the image capture device.

The rendered depth images are provided from the simulation platform 201 to the compute shaders pre-processing layer 205. The compute shaders pre-processing layer 205 simulates noise from pre-processing due to the optics of the lens of the light sensor and shutter effects of the sensor during image capture. The rendered depth images output by the simulation platform 201 are distorted to account for the noise from pre-processing.

For example, after rendering by the simulation platform 201, the compute shaders pre-processing layer 205 applies pre-processing effects to the rendered images. The compute shaders pre-processing layer 205 simulates the same lens distortion as exists in the real-world light sensor. For example, an image captured of the projected pattern real-world light sensor may be distorted by radial or tangential lens distortion, such as barrel distortion, pincushion distortion, mustache/complex distortion, etc. Other types of distortion may also be simulated. The compute shaders pre-processing layer 205 also simulates noise resulting from one or more scratches on the real-world lens of the camera, as well as noise from lens grain. Other noise types may also be simulated by the compute shaders pre-processing layer 205. For example, real-world light sensor may be affected by random noise throughout the depth image (e.g., independent and identically distributed (i.i.d.) noise).

The compute shaders pre-processing layer 205 further applies pre-processing effects of the shutter. For example, different light sensors capture depth images using different shutter types, such as global shutter, rolling shutter, etc. Each type of shutter has different effects on the captured depth images. For example, using a global shutter, every pixel of a sensor captures image data at the same time. In some electronic shutters, a rolling shutter may be employed to increase speed and decrease computational complexity and cost of image capture. Rolling shutter does not expose all pixels of the sensor at the same time. For example, a rolling shutter may expose a series of lines of pixels of the sensor. As a result, there will be a slight time difference between lines of capture image data, increasing noise due to motion of the sensor during image capture. The compute shaders pre-processing layer 205 applies pre-processing to simulate the shutter effects in the rendered images. The effect of motion blur may also be applied to the rendered images. Motion blur is the blurring, or apparent streaking effect, resulting from movement of the camera during exposure (e.g., caused by rapid movement or a long exposure time). In this manner, the shutter effects are modeled together with the motion pattern, simulating degraded matching and decoding performance associated with the different types of shutters. After applying the pre-processing effects, the compute shaders pre-processing layer 205 provides the distorted, rendered depth images to the block matching and reconstruction layer 207.

The block matching and reconstruction layer 207 performs depth reconstruction from the rendered depth images to generate depth maps. After rendering and pre-processing, depth reconstruction is performed by rectifying, decoding and matching the rendered images with the raw projector pattern received from the pattern simulator 203 to generate depth maps. The exact reconstruction algorithm varies from sensor to sensor. For example, pseudo random dot pattern based sensors may rely on stereo block matching algorithms and stripe pattern based sensors may extract the center lines of the pattern on the captured images before decoding the identities of each stripe on the image. As such, block matching and reconstruction layer 207 models the reconstruction algorithm embedded in the target sensor.

For example, three-dimensional point cloud data is generated from the rendered images. The three-dimensional point cloud data is generated from features extracted from the pattern (e.g., centerlines of the alternating striped pattern) in the rendered images. The block matching and reconstruction layer 207 takes into account how the depth images were generated, such as using multi-shot or single-shot structured light sensors and the raw projector pattern. The generated point cloud data is generated in a depth map reconstruction of the object from the rendered depth images. The block matching and reconstruction layer 207 provides the depth map reconstruction to the compute shaders post-processing layer 209.

The compute shaders post-processing layer 209 applies post-processing to the depth map in accordance with the electronics of the real-world light sensor. For example, the depth maps are smoothed and trimmed according to the measurement range from the real-world sensor specifications. Further, simulating the operations performed by the electronics of the real-world sensor, corrections for hole-filling and smoothing (e.g., applied to reduce the proportion of missing data in captured depth data) are applied to the depth map by the compute shaders post-processing layer 209. After post-processing, the depth map contains simulated depth data with the same characteristics and noise of the real-world light sensor.

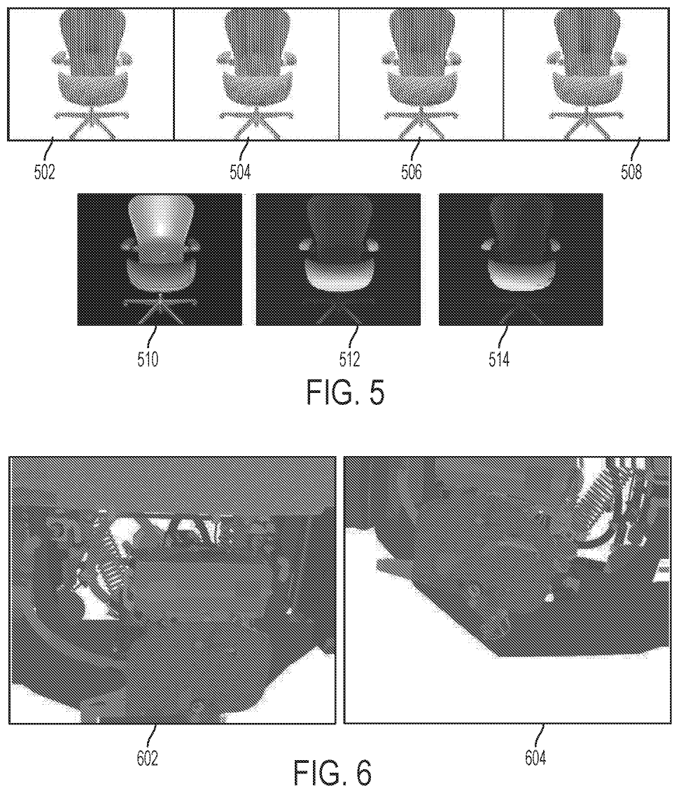

FIG. 5 illustrates an example of generating synthetic depth data for multi-shot structured light sensors. In this example, synthetic data is generated for a chair. At 502-508, a complete exposure set of four different patterns are simulated and rendered for the target object. The projected patterns are rendered under realistic lighting for a real-world sensor and realistic surface material properties of the target object (e.g., by simulation platform 201). At 510, a color rendering with depth data (e.g., red, green, blue+depth (RGB+D) data) may be generated (e.g., by simulation platform 201). At 512, ideal depth map is generated without noise associated with the real-world sensor (e.g., by simulation platform 201). At 514, reconstructed depth map incorporates noise characteristics of the real-world sensor (e.g., by compute shaders pre-processing layer 205, block matching and reconstruction layer 207 and/or compute shaders post-processing layer 209). As depicted in 514, the reconstructed depth map includes noise in the same manner as a real-world sensor (e.g., noise not present in the ideal depth map).

FIGS. 6-13 depict different depth maps and rendered images for different sensor characteristics (e.g., pattern and motion) and environmental characteristics (e.g., lighting and material). An engine of a high speed train is depicted in FIGS. 6-13 as the target object.

FIG. 6 illustrates an example of an ideal depth map rendering of the target object. At 602, an ideal simulated color rendering of the target object is generated using a three-dimensional CAD model. At 604, an ideal depth map corresponding to the simulated color rendering 602 is depicted. The color rendering 602 and the depth map 604 do not include noise similar to a real-world sensor.

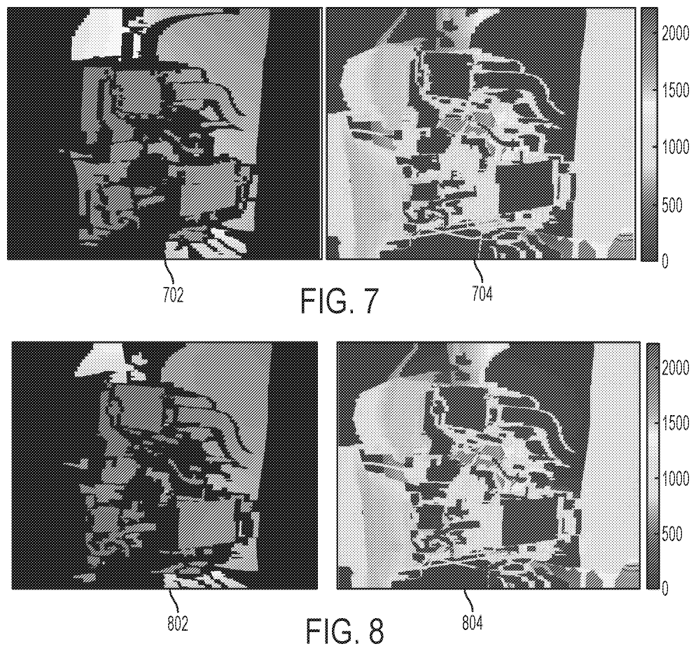

FIG. 7 illustrates an example of the realistically rendered depth map of the target object. Using the multi-shot structured light sensor model, reconstructed depth map 702 incorporates the characteristics of the real-world sensor. At 704, an error map is depicted comparing the reconstructed depth map 702 to an ideal depth map. As depicted in 704, the error map represents errors produced by the incorporated noise in the same manner as the real-world sensor models the same errors introduced by a real-world sensor.

FIG. 8 illustrates another example of the realistically rendered depth map of the target object. Using the multi-shot structured light sensor model, reconstructed depth map 802 incorporates rolling shutter effects of the real-world sensor. For example, depth map 802 incorporates the error resulting from motion between two exposures (e.g., 2 mm parallel to horizontal direction of camera image plane). At 804, an error map is depicted comparing the reconstructed depth map 802 to an ideal depth map. As depicted in 804, the error map represents errors produced by the incorporated shutter effects in the same manner as the real-world sensor models the same errors introduced by a real-world sensor.

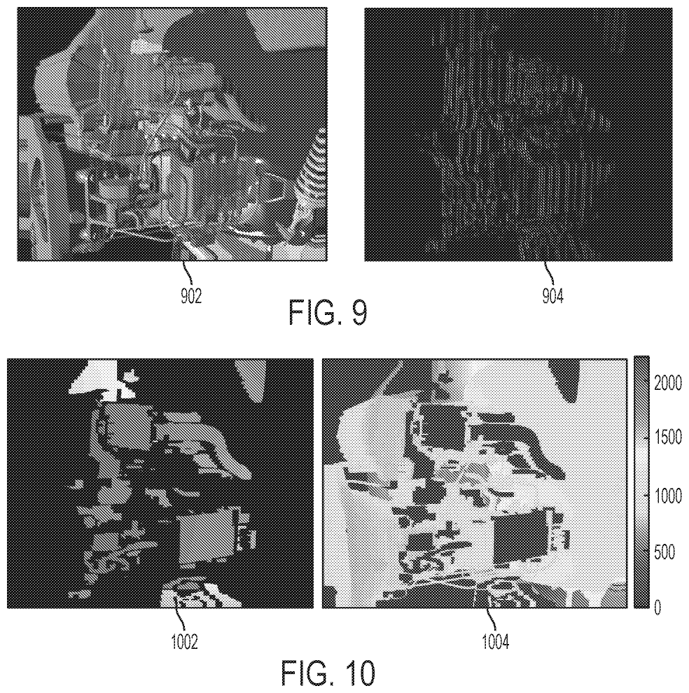

FIGS. 9-10 illustrate another example of the realistically rendered depth map of the target object. Using the multi-shot structured light sensor model, reconstructed depth map 904 incorporates strong ambient light. As depicted in 902, the projected pattern is captured by the camera in normal ambient lighting conditions. Under strong ambient lighting conditions, the pattern is more difficult to capture. Depth map 904 depicts the pattern of depth map 902 after the strong ambient light (e.g., no pattern exposure). At 1004, an error map is depicted comparing the reconstructed depth map 1002 to an ideal depth map. As depicted in 1004, the error map represents the error by incorporating the strong ambient light in the same manner as the real-world environment introduces the same errors as a real-world sensor in the same environment.

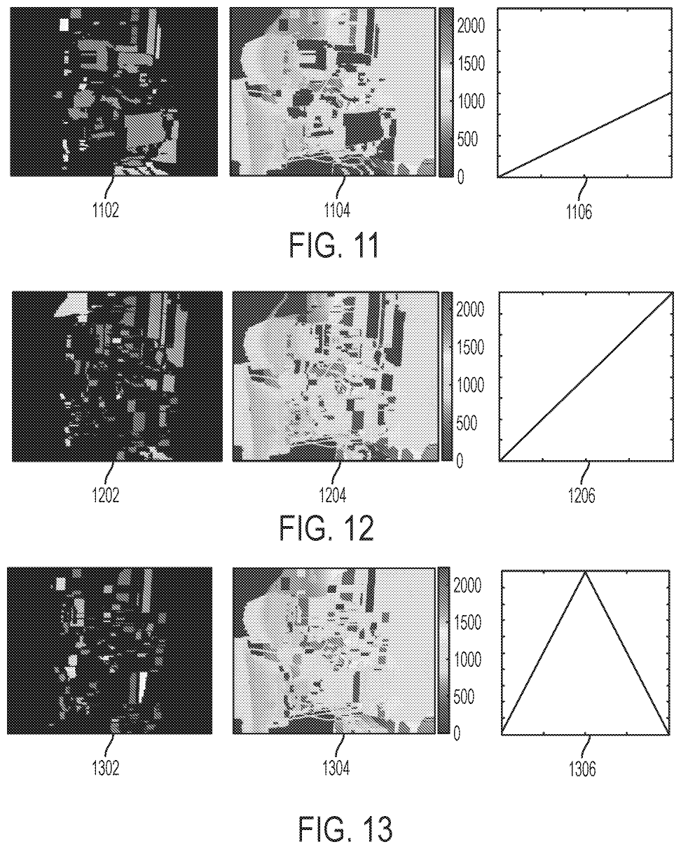

FIGS. 11-13 illustrate another example of the realistically rendered depth map of the target object. FIGS. 11-13 depict rendered depth maps generated from simulating different motion patterns between exposures. FIG. 11 depicts slow, uniform speed of 10 mm/s in each direction (x, y, z). The error graph 1106 of the reconstructed depth map 1102 compared to the ideal depth map 1104 shows the minor errors resulting from the slow movement pattern. FIG. 12 depicts rapid, uniform speed of 20 mm/s in each direction (x, y, z). The error graph 1206 of the reconstructed depth map 1202 compared to the ideal depth map 1204 shows the increased errors resulting from the rapid movement pattern when compared to the slow movement pattern. FIG. 13 depicts rapid shaking of 20 mm/s in each direction (x, y, z). The error graph 1306 of the reconstructed depth map 1302 compared to the ideal depth map 1304 shows the greatest errors resulting from the shaking movement pattern when compared to the slow and rapid uniform movement patterns.

FIG. 14 illustrates a flowchart diagram of another embodiment of a method for synthetic depth data generation. The method is implemented by the system of FIG. 15 (discussed below), FIG. 16 (discussed below) and/or a different system. Additional, different or fewer acts may be provided. For example, one or more acts may be omitted, such as acts 1407 and 1409. The method is provided in the order shown. Other orders may be provided and/or acts may be repeated. For example, act 1405 may be repeated to generate multiple sets of synthetic depth data, such as for different objects or object poses. Further, the acts may be performed concurrently as parallel acts.

At act 1401, a three-dimensional model of an object is received, such as three-dimensional computer-aided design (CAD) data. For example, a three-dimensional CAD model and the material properties of the object may be imported or loaded from remote memory. The three-dimensional model of the object may be the three-dimensional CAD model used to design the object, such as the engine of a high speed train.

At act 1403, a three-dimensional sensor or camera is modeled. For example, the three-dimensional sensor is a multi-shot pattern-based structured light sensor. As discussed above, the sensor characteristics (e.g., pattern and/or motion), environment (e.g., lighting) and/or processing (e.g., software and/or electronics) are modeled after a real-world sensor. In a light sensor including a projector and a camera, the pattern of the projector is modeled. Simulating the three-dimensional sensor accounts for noise related to the sensor structure (e.g., lens distortion, scratch and grain) and/or the dynamic effects of motion between exposures that impacts the projection and capture of the light pattern.

Any type of projected pattern may be modeled, such as alternating striped patterns according to binary code, gray code, phase shift, gray code+phase shift, etc. Alternatively, the projected pattern of the light sensor may be imported or loaded from remote memory as an image asset. The projected patterns are modeled by light cookies with pixel intensities represented by alpha channel values.

The motion associated with the light sensor is modeled. For example, when the sensor is capturing one or more images of the pattern, the camera may move due to human interaction (e.g., a human's inability to hold the camera still). Modeling the multi-shot pattern based structured light sensor includes modeling the effect of this motion between exposures on the acquired data. When modeling image capture, motion between each exposure is also modeled to reflect the influence brought by exposure time, interval between exposures, motion blur, and the number of exposures (e.g., different patterns captured by the camera). The electronic shutter used by the light sensor is also modeled, such as a global or rolling shutter. Modeling shutter allows for simulating degraded matching and decoding performance associated with different types of shutters.

Environmental illuminations associated with the light sensor are also modeled. For example, strong ambient light or other light sources may decrease the ability of the camera to capture the projected pattern. The various ambient and other light sources of the environment of the real-world sensor are model to account for the negative impact of lighting on image capture.

Analytical processing associated with the light sensor is modeled. For example, software and electronics used to generate a depth image from the captured image data may be modeled so that the synthetic image data accurately reflects the output of the light sensor. The analytical processing is modeled to include hole-filling, smoothing and trimming for the synthetic depth data.

At act 1405, synthetic depth data is generated using the multi-shot pattern based structured light sensor model. For example, the synthetic depth data is generated based on three-dimensional CAD data. The synthetic depth data may be labeled or annotated for machine learning (e.g., ground truth data). Each image represented by the synthetic depth data is for a different pose of the object. Any number of poses may be used. For example, synthetic depth data may be generated by rendering depth images and reconstructing point cloud data from the rendered images from different view points.

At act 1407, an algorithm is trained based on the generated synthetic depth data. For example, the algorithm may be a machine learning artificial agent, such as a convolutional neural network. The convolutional neural network is trained to extract features from the synthetic depth data. In this training stage, the convolutional neural network is trained using labeled poses from the synthetic training data. Training data captured of the object by the light sensor may also be used.

At act 1409, a pose of the object is estimated using the trained algorithm. For example, using the trained algorithm, feature database(s) may be generated using the synthetic image data. A test image of the object is received and a nearest pose is identified from the feature database(s). The pose that most closely matches the received image provides or is the pose for the test image. Interpolation from the closest pose may be used for a more refined pose estimate.

FIG. 15 illustrates system an embodiment of a system for synthetic depth data generation. For example, the system is implemented on a computer 1502. A high-level block diagram of such a computer 1502 is illustrated in FIG. 15. Computer 1502 includes a processor 1504, which controls the overall operation of the computer 1502 by executing computer program instructions which define such operation. The computer program instructions may be stored in a storage device 1512 (e.g., magnetic disk) and loaded into memory 1510 when execution of the computer program instructions is desired. The memory 1510 may be local memory as a component of the computer 1502, or remote memory accessible over a network, such as a component of a server or cloud system. Thus, the acts of the methods illustrated in FIG. 1 and FIG. 4 may be defined by the computer program instructions stored in the memory 1510 and/or storage 1512, and controlled by the processor 1504 executing the computer program instructions. An image acquisition device 1509, such as a three-dimensional scanner, may be connected to the computer 1502 to input image data to the computer 1502. It is also possible to implement the image acquisition device 1509 and the computer 1502 as one device. It is further possible that the image acquisition device 1509 and the computer 1502 communicate wirelessly through a network.

Image acquisition device 1509 is any three-dimensional scanner or other three-dimensional camera. For example, the three-dimensional scanner is a camera with a structured-light sensor, or a structured-light scanner. A structured-light sensor is a scanner that includes a camera and a projector. The projector projects structured light patterns that are captured by the camera. A multi-shot structured light sensor captures multiple images of a projected pattern on the object. The captured images of the pattern are used to generate the three-dimensional depth image of the object.

The computer 1502 also includes one or more network interfaces 1506 for communicating with other devices via a network, such as the image acquisition device 1509. The computer 1502 includes other input/output devices 1508 that enable user interaction with the computer 1502 (e.g., display, keyboard, mouse, speakers, buttons, etc.). Such input/output devices 1508 may be used in conjunction with a set of computer programs as an annotation tool to annotate volumes received from the image acquisition device 1509. One skilled in the art will recognize that an implementation of an actual computer could contain other components as well, and that FIG. 15 is a high level representation of some of the components of such a computer for illustrative purposes.

For example, the computer 1502 may be used to implement a system for synthetic depth data generation. Storage 1512 and/or memory 1510 is configured to store a three-dimensional simulation of an object. Processor 1504 is configured to receive depth data or depth image of the object captured by a sensor or camera of a mobile device. Processor 1504 also receives data indicative of characteristics of the sensor or camera of the mobile device. Processor 1504 is configured to generate a model of the sensor or camera of the mobile device. For example, for a structured light sensor of a mobile device, processor 1504 models a projector and a perspective camera of the light sensor. Modeling the light sensor may include rendering synthetic pattern images based on the model of the sensor and then applying pre-processing and post-processing effects to the generated synthetic pattern images. Pre-processing effects may include shutter effects, lens distortion, lens scratch, lens grain, motion blur and other noise. Post-processing comprise smoothing, trimming, hole-filling and other processing.

Processor 1504 is further configured to generate synthetic depth data based on a stored three-dimensional simulation of an object (e.g., a three-dimensional CAD model) and the modeled light sensor of the mobile device. The generated synthetic depth data may be labeled with ground-truth poses. Point cloud data from the processed synthetic pattern images. Processor 1504 may also be configured to train an algorithm based on the generated synthetic depth data. The trained algorithm may be used to estimate a pose of the object from the received depth data or depth image of the object.

FIG. 16 illustrates another embodiment of a system for synthetic depth data generation. The system allows for synthetic depth data generation by one or both of a remote workstation 1605 or server 1601 simulating the sensor 1609 of a mobile device 1607.

The system 1600, such as an imaging processing system, may include one or more of a server 1601, a network 1603, a workstation 1605 and a mobile device 1607. Additional, different, or fewer components may be provided. For example, additional servers 1601, networks 1603, workstations 1605 and/or mobile devices 1607 are used. In another example, the servers 1601 and the workstation 1605 are directly connected, or implemented on a single computing device. In yet another example, the server 1601, the workstation 1605 and the mobile device 1607 are implemented on a single scanning device. As another example, the workstation 1605 is part of the mobile device 1607. In yet another embodiment, the mobile 1607 performs the image capture and processing without use of the network 1603, server 1601, or workstation 1605.

The mobile device 1607 includes sensor 1609 and is configured to capture a depth image of an object. The sensor 1609 is a three-dimensional scanner configured as a camera with a structured-light sensor, or a structured-light scanner. For example, the depth image may be captured and stored as point cloud data.

The network 1603 is a wired or wireless network, or a combination thereof. Network 1603 is configured as a local area network (LAN), wide area network (WAN), intranet, Internet or other now known or later developed network configurations. Any network or combination of networks for communicating between the client computer 1605, the mobile device 1607, the server 1601 and other components may be used.

The server 1601 and/or workstation 1605 is a computer platform having hardware such as one or more central processing units (CPU), a system memory, a random access memory (RAM) and input/output (I/O) interface(s). The server 1601 and workstation 1605 also includes a graphics processor unit (GPU) to accelerate image rendering. The server 1601 and workstation 1605 is implemented on one or more server computers connected to network 1603. Additional, different or fewer components may be provided. For example, an image processor 1609 and/or renderer 1611 may be implemented (e.g., hardware and/or software) with one or more of the server 1601, workstation 1605, another computer or combination thereof.

Various improvements described herein may be used together or separately. Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

We claim:

1. A method for real-time synthetic depth data generation, the method comprising:
receiving (1401), at an interface, three-dimensional computer-aided design (CAD) data of an object;
modeling (1403) a multi-shot pattern based structured light sensor; and
generating (1405) synthetic depth data using the multi-shot pattern based structured light sensor model, the synthetic depth data based on three-dimensional CAD data.

2. The method of claim 1, wherein modeling (1403) the multi-shot pattern based structured light sensor comprises modeling the effect of motion between exposures on acquisition of multi-shot structured light sensor data.

3. The method of claim 1, wherein modeling the effect of motion between exposures on acquisition of multi-shot structured light sensor data comprises modeling the influence of exposure time.

4. The method of claim 1, wherein modeling the effect of motion between exposures on acquisition of multi-shot structured light sensor data comprises modeling an interval between exposures.

5. The method of claim 1, wherein modeling the effect of motion between exposures on acquisition of multi-shot structured light sensor data comprises modeling motion blur.

6. The method of claim 1, wherein modeling the effect of motion between exposures on acquisition of multi-shot structured light sensor data comprises modeling the influence of a number of pattern exposures.

7. The method of claim 1, wherein modeling (1403) the multi-shot pattern based structured light sensor comprises modeling the pattern modeling.

8. The method of claim 1, wherein modeling the pattern modeling comprises modeling the effect of light sources.

9. The method of claim 1, wherein modeling the effect of light sources comprises modeling the effect of ambient light.

10. The method of claim 1, wherein modeling the pattern modeling comprises modeling the effect of a rolling shutter or a global shutter.

11. A system for synthetic depth data generation, the system comprising:
a memory (1510) configured to store a three-dimensional simulation of an object; and
a processor (1504) configured to:
receive depth data of the object captured by a sensor of a mobile device;
generate a model of the sensor of the mobile device;
generate synthetic depth data based on the stored three-dimensional simulation of an object and the model of the sensor of the mobile device;
train an algorithm based on the generated synthetic depth data; and
estimate, using the trained algorithm, a pose of the object based on the received depth data of the object.

12. The system of claim 11, wherein the processor (1504) is further configured to:
receive data indicative of the sensor of the mobile device.

13. The system of claim 11, wherein the generated synthetic depth data comprises labeled ground-truth poses.

14. The system of claim 11, wherein generating the model of the sensor of the mobile device comprises:
modeling a projector of the sensor; and
modeling a perspective camera of the sensor.

15. The system of claim 11, wherein generating the synthetic depth data comprises:
rendering synthetic pattern images based on the model of the sensor;
applying pre-processing effects to the synthetic pattern images;
applying post-processing effects to the synthetic pattern images; and
constructing point cloud data from the processed synthetic pattern images.

16. The system of claim 15, wherein:
applying pre-processing effects comprise shutter effect, lens distortion, lens scratch and grain, motion blur, and noise; and
wherein applying post-processing comprise smoothing, trimming, and hole-filling.

17. A method for synthetic depth data generation, the method comprising:
simulating (101) a sensor for capturing depth data of a target object;
simulating (103) environmental illuminations for capturing depth data of the target object;
simulating (105) analytical processing of captured depth data of the target object; and
generating (107) synthetic depth data of the target object based on the simulated sensor, environmental illuminations and analytical processing.

18. The method of claim 17, wherein simulating (101) the sensor comprises simulating quantization effects, lens distortions, noise, motion, and shutter effects.

19. The method of claim 17, wherein simulating (103) environmental illuminations comprise simulating ambient light and light sources.

20. The method of claim 17, wherein simulating (105) comprises simulating smoothing, trimming, and hole-filling.
